(19) United States
(12) Patent Application Publication
(10) Pub. No.: US 2006/0240882 A1
(43) Pub. Date: Oct. 26, 2006

(54) Self-structuring antenna arrangement

(76) Inventors: Louis L. Nagy, Warren, MI (US); Mark K. Krage, Troy, MI (US); Andrzej M. Pawlak, Rochester Hills, MI (US)

Correspondence Address: DELPHI TECHNOLOGIES, INC., M/C 480-410-202, PO BOX 5052, TROY, MI, 48007, US

(21) Appl. No.: 11/114,812

(22) Filed: Apr. 26, 2005

(51) Int. Cl. H04B 1/06; H04M 1/00; H04B 7/00

(52) U.S. Cl. 455/575.7; 455/269

(57) ABSTRACT

An antenna arrangement includes an antenna circuit for receiving and/or transmitting radio frequency signals. A signal feed circuit is coupled with the antenna circuit. A performance-adjusting device includes at least one of: a structure feed switch selectively interconnecting the antenna circuit and the signal feed circuit; a variable impedance element disposed in the antenna circuit or the signal feed circuit; and a switchable parasitic element coupled to the antenna circuit. A controller controls the performance-adjusting device.

### TECHNICAL BACKGROUND

The present invention relates to antenna arrangements, and, more particularly, to self-structuring antenna arrangements.

### BACKGROUND OF THE INVENTION

The performance of conventional antennas is limited by the fixed antenna configuration. Even with a reconfigurable antenna there is a fixed number of predetermined antenna and feed configurations, which limits performance. Thus, it is advantageous for an antenna to be self-structuring such that the performance of the antenna may be optimized to best receive or transmit signals of a particular frequency, or to best receive or transmit signals in a particular environment. Self-structuring is conventionally achieved by providing controllable switches at various points along the antenna, and opening and closing the switches to thereby alter the shape of the electrical skeleton of the antenna.

Known self-structuring antenna (SSA) technology is limited to a basic configuration that uses a single point feed system connected to a single antenna template having a large number of switches. These restrictions have a negative impact on the SSA's potential performance and flexibility for many applications. The design process for SSAs must consider the various conflicts between the ideal antenna design, physical structure limitations, and mobile environmental requirements. In reality, the resulting SSA design is inevitably a compromise.

What is needed in the art is an antenna arrangement that may be structured in a greater variety of ways to thereby enable the antenna performance to be further optimized for specific frequencies and environments.

### SUMMARY OF THE INVENTION

The present invention provides an antenna arrangement that incorporates multiple flexible building blocks, such as a self-structuring feed (SSF), self-structuring variable impedance elements (SSVIE), and self-structuring parasitic elements (SSPE) systems. The performance of known conventional, reconfigurable and/or SSA antenna configurations may be enhanced by use of the flexible building blocks of the present invention.

The invention comprises, in one form thereof, an antenna arrangement including an antenna circuit for receiving and/or transmitting radio frequency signals. A signal feed circuit is coupled with the antenna circuit. A performance-adjusting device includes at least one of: a structure feed switch selectively interconnecting the antenna circuit and the signal feed circuit; a variable impedance element disposed in the antenna circuit or the signal feed circuit; and a switchable parasitic element coupled to the antenna circuit. A controller controls the performance-adjusting device.

The invention comprises, in another form thereof, an antenna arrangement including an antenna circuit for receiving and/or transmitting radio frequency signals. A self-structure feed switch selectively interconnects the antenna circuit and a signal feed circuit. A controller controls the self-structure feed switch.

The invention comprises, in yet another form thereof, an antenna arrangement including an antenna circuit for receiving and/or transmitting radio frequency signals. A signal feed circuit is in communication with the antenna circuit. A variable impedance element is disposed in the antenna circuit or the signal feed circuit. A controller controls the variable impedance element.

The invention comprises, in still another form thereof, an antenna arrangement including an antenna circuit for receiving and/or transmitting radio frequency signals. A signal feed circuit is in communication with the antenna circuit. A switchable parasitic element is coupled to the antenna circuit. A controller controls the switchable parasitic element.

An advantage of the present invention is that the antenna arrangement can be configured in a greater number of ways to thereby optimize the reception/transmission performance of the antenna at various frequencies and environments.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of one embodiment of an antenna arrangement of the present invention including a self-structure feed system.

FIG. 2 is a schematic diagram of another embodiment of an antenna arrangement of the present invention including a self-structuring variable impedance element system.

FIG. 3 is a schematic diagram of yet another embodiment of an antenna arrangement of the present invention including a self-structure parasitic element system.

FIG. 4 is a schematic diagram of a further embodiment of an antenna arrangement of the present invention including a SSA, SSF and SSVIE slot antenna system.

FIG. 5 is a schematic diagram of still another embodiment of an antenna arrangement of the present invention including a SSA, SSF and SSVIE slot antenna system.

FIG. 6 is a schematic diagram of another embodiment of an antenna arrangement of the present invention including a SSF and SSVLIE dipole antenna system.

FIG. 7 is a schematic diagram of yet another embodiment of an antenna arrangement of the present invention including a SSPE-slot antenna system.

FIG. 8 is a schematic diagram of a further embodiment of an antenna arrangement of the present invention including a SSPE and SSA dipole antenna system.

FIG. 9 is a schematic diagram of still another embodiment of an antenna arrangement of the present invention including a SSF, SSVIE and SSPE slot antenna system.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

The embodiments discussed below are not intended to be exhaustive or limit the invention to the precise forms disclosed in the following detailed description. Rather, the embodiments are chosen and described so that others skilled in the art may utilize their teachings.

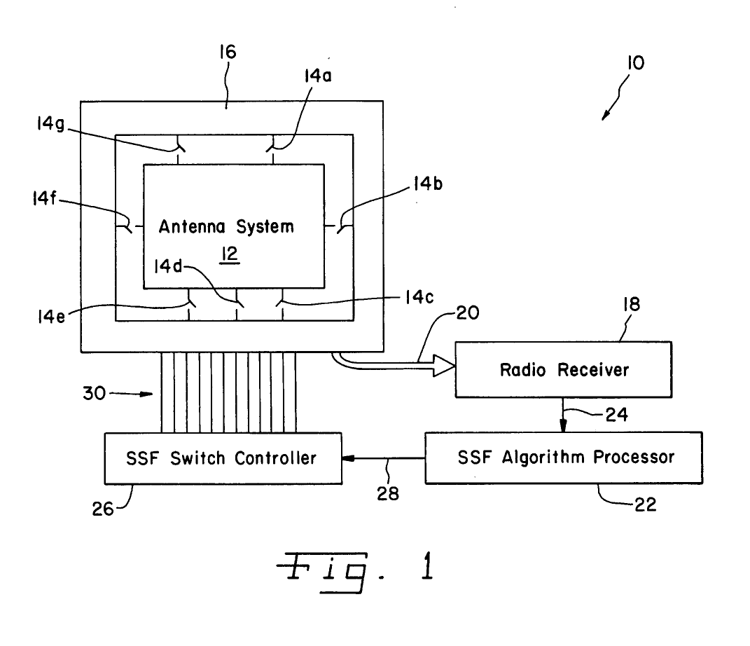

Referring now to the drawings, and particularly to FIG. 1, there is shown one embodiment of an antenna arrangement 10 of the present invention including an antenna circuit 12 for receiving and/or transmitting radio frequency signals, self-structure feed (SSF) ports or switches 14 for selectively interconnecting antenna circuit 12 and a signal feed circuit in the form of a multiple feed template 16, a radio receiver 18 receiving signals 20 from template 16, an SSF algorithm processor 22 receiving an output signal 24 from radio receiver 18, an SSF switch controller 26 receiving an output signal 28 from processor 22, and control lines 30 interconnecting controller 26 and switches 14. Antenna circuit 12 is shown only schematically in FIG. 1, but may be in the form of a slot antenna circuit, a dipole antenna circuit, or any other antenna circuit.

As shown in FIG. 1, self-structure feed switches 14 may selectively interconnect antenna circuit 12 and signal feed circuit 16 at respective spaced apart locations along a perimeter of antenna circuit 12. However, switches 14 may be disposed at any locations between antenna circuit 12 and signal feed circuit 16. Moreover, although seven switches 14 are shown in FIG. 1, antenna arrangement 10 may include any number of switches 14.

In operation, each of the self-structure feed switches 14a-g may be independently actuated by controller 26 between a first position in which antenna circuit 12 and template 16 are in communication through switch 14, and a second position in which antenna circuit 12 and template 16 are not in communication through switch 14. Switches 14 may function as a performance-adjusting device for improving the signal reception and/or signal transmission performance of antenna arrangement 10. In one embodiment, controller 26 and processor 22 control switches 14 dependent upon signal 20 received by radio receiver 18 via antenna arrangement 10.

Switches 14a-g may begin in various combinations of the first and second positions when antenna circuit 12 passes a received signal to receiver 18 via the switches 14, via template 16, and via signal 20. Processor 22 may analyze output signal 24 to determine the signal strength, signal-to-noise ratio and/or some other attribute of the signals 20 passed to receiver 18. Controller 26 may receive via signal 28 the analysis produced by processor 22 and record both the performance of antenna arrangement 10, as represented by the analysis, and the positions of each of switches 14 that produced that particular performance. Switch controller 26 may then actuate at least one of switches 14 between the first and second positions to thereby provide antenna arrangement 10 with a different level of performance. Controller 26 may again record the switch positions and the corresponding antenna performance produced thereby. The process may continue with controller 26 changing and recording switch positions and recording the resulting performance until controller 26 has determined a combination of switch positions that produces an optimal, favorable, or at least acceptable antenna performance.

Controller 26 may try every possible combination of switch positions during the above process. Alternatively, controller 26 may only sample a number of combinations of switch positions and pick the best combination of the number sampled. As another alternative, controller 26 may include some intelligence that enables controller 26 to systematically select particular switch combinations that are likely to yield good performance. The switch combinations may be selected, for example, based upon recognized patterns in the performance of previously selected combinations of switch positions.

Controller 26 may include memory in which an operational database may be stored. The database may include the best combination of switch positions for each of a list of possible operating conditions. Experimentation or trials to determine the best switch combinations may occur in the factory, in the field, and/or may be ongoing over the operational life of the antenna system.

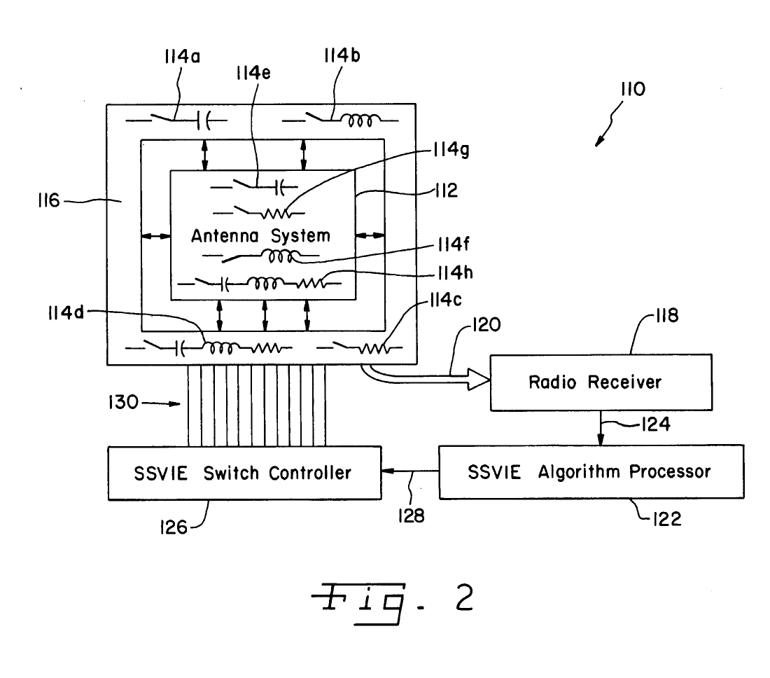

Another embodiment of an antenna arrangement 110 of the present invention including an antenna circuit 112 for receiving and/or transmitting radio frequency signals is shown in FIG. 2. Arrangement 110 also includes switchable, self-structuring variable impedance elements (SSVIE) 114a-f for selectively adding a variable impedance load to the antenna circuit 112 and/or to a signal feed circuit 116 that is in communication with antenna circuit 112. Elements 114 may be used for impedance matching. Elements 114a-d are connected to feed circuit 116, and elements 114e-h are connected to antenna circuit 112. Elements 114a, 114e are switchable capacitive loads, elements 114b, 114f are switchable inductive loads, elements 114c, 114g are switchable resistive loads, and elements 114d, 114h are switchable capacitive, inductive, and/or resistive loads. Any or all of elements 114a-d may be selectively connected in parallel and/or series with feed circuit 116. Similarly, any or all of elements 114e-h may be selectively connected in parallel and/or series with antenna circuit 112. Each of elements 114 has a respective switch device shown schematically in FIG. 2 that may be actuated to thereby connect or disconnect the element 114 to/from antenna circuit 112 or feed circuit 116.

Antenna arrangement 110 also includes a radio receiver 118 receiving signals 120 from feed circuit 116, an SSVIE algorithm processor 122 receiving an output signal 124 from radio receiver 118, an SSVIE switch controller 126 receiving an output signal 128 from processor 122, and control lines 130 interconnecting controller 126 and the switch devices of self-structuring variable impedance elements (SSVIE) 114a-h. Antenna circuit 112 is shown only schematically in FIG. 2, but may be in the form of a slot antenna circuit, a dipole antenna circuit, or any other antenna circuit.

In the embodiment shown in FIG. 2, one capacitive switchable element 114, one inductive switchable element 114, one resistive switchable element 114, and one capacitive, inductive, and resistive switchable element 114 is provided in each of antenna circuit 112 and feed circuit 116. However, it is possible for any number of capacitive switchable elements 114, any number of inductive switchable elements 114, any number of resistive switchable elements 114, and any number of capacitive, inductive, and resistive switchable elements 114 to be included in either one of antenna circuit 112 and signal feed circuit 116. Moreover, elements 114 may all have different impedance values, including different capacitances and different inductances. In one embodiment, elements 114 are sections of coaxial cable having different lengths and, therefore different impedances, i.e., different capacitances, inductances, and resistances.

The operation of antenna arrangement 110 is substantially similar to that of antenna arrangement 10, and thus is not discussed herein in detail. Generally, controller 126 controls elements 114 dependent upon a signal received by receiver 118 via antenna arrangement 110. Controller 126 and processor 122 may open and close the switch devices of elements 114 in different combinations and then determine which of the combinations results in the best antenna performance.

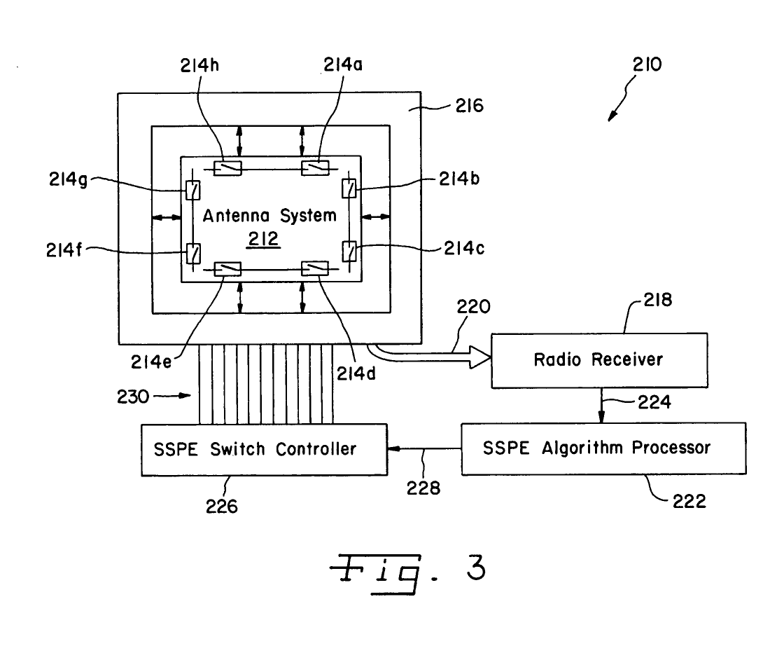

Yet another embodiment of an antenna arrangement 210 (FIG. 3) of the present invention includes an antenna circuit 212 for receiving and/or transmitting radio frequency signals, and switchable, self-structuring parasitic elements (SSPE) 214a-h coupled to antenna circuit 212. Parasitic elements 214 may be used to selectively exert parasitic effects on antenna circuit 212. Antenna arrangement 210 also includes a signal feed circuit 216 in communication with antenna circuit 212, a radio receiver 218 receiving signals 220 from feed circuit 216, an SSPE algorithm processor 222 receiving an output signal 224 from radio receiver 218, an SSPE switch controller 226 receiving an output signal 228 from processor 222, and control lines 230 interconnecting controller 226 and the switchable parasitic elements 214a-h. Antenna circuit 212 is shown only schematically in FIG. 3, but may be in the form of a slot antenna circuit, a dipole antenna circuit, or any other antenna circuit.

The operation of antenna arrangement 210 is substantially similar to that of antenna arrangement 10, and thus is not discussed herein in detail. Generally, controller 226 controls switchable parasitic elements 214 dependent upon a signal received by receiver 218 via antenna arrangement 210. Controller 226 and processor 222 may open and close the switchable elements 214 in different combinations and then determine which of the combinations results in the best antenna performance.

All three of antenna arrangements 10, 110 and 210 may use an output signal from a communication device, in the form of an antenna, in combination with an algorithm to obtain superior antenna characteristics. The SSF, SSVIE and SSPE systems of FIGS. 1-3, respectively, may be used separately or in various combinations.

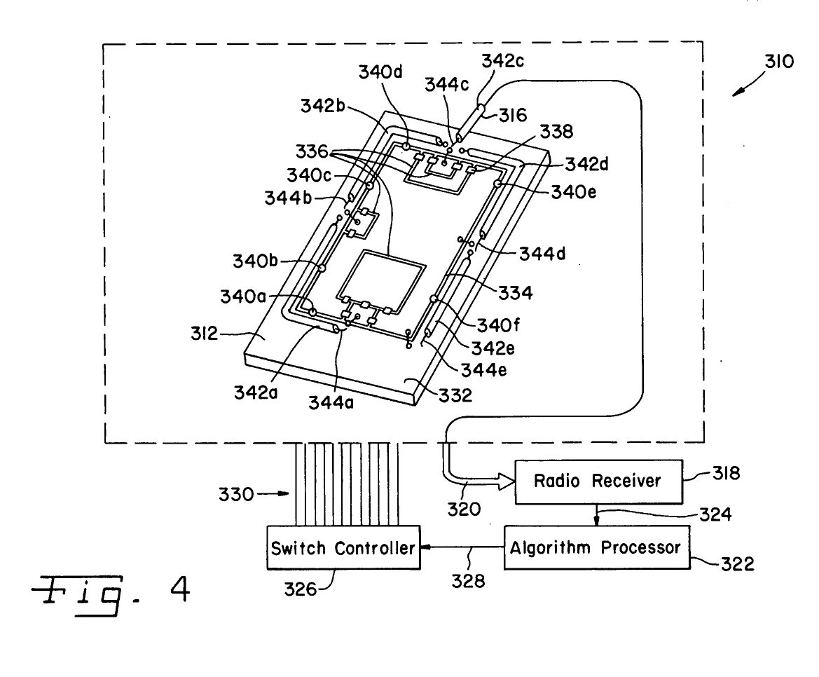

An antenna arrangement 310 including both an SSF system and an SSVIE system is shown in FIG. 4. Arrangement 310 includes a slot antenna 312 formed by a rectangular conductive substrate 332 having a rectangular throughslot 334 therein. Slot antenna 312 also includes other slot sections 336 having self-structuring antenna (SSA) switches 338. Arrangement 310 also includes switchable, self-structuring variable impedance elements 340a-f disposed across slot 334. A signal feed circuit 316 including sections 342a-e of coaxial cable is connected to slot antenna 312 by self-structuring feed switches 344a-e. Antenna arrangement 310 also includes a radio receiver 318 receiving signals 320 from feed circuit 316, an algorithm processor 322 receiving an output signal 324 from radio receiver 318, a switch controller 326 receiving an output signal 328 from processor 322, and control lines 330 interconnecting controller 326 and SSA elements 336, self-structuring variable impedance elements 340, and self-structuring feed switches 344.

The operation of antenna arrangement 310 is substantially similar to that of antenna arrangement 10, and thus is not discussed herein in detail. Generally, controller 326 and processor 322 control SSA slot elements 336, SSVIE loads 340 and SSF switches 344 dependent upon a signal received by receiver 318 via antenna arrangement 310. Controller 326 may open and close the switches 338, 340, 344 in different combinations and then determine which of the combinations results in the best antenna performance. Algorithm processor 322 may be in the form of an SSA algorithm processor that is capable of controlling SSA slot elements 336, SSVIE loads 340 and SSF switches 344.

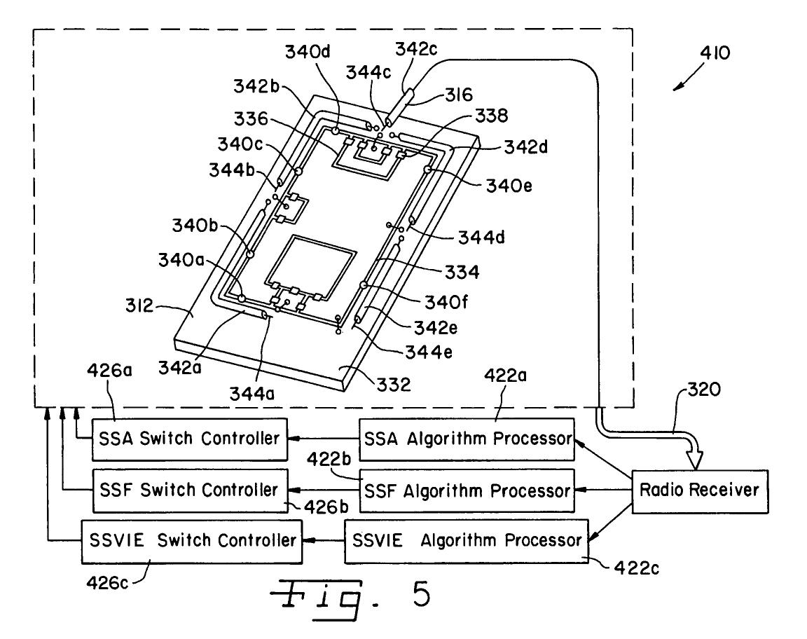

Another embodiment of an antenna arrangement 410 including both an SSF system and an SSVIE system is shown in FIG. 5. Arrangement 410 is substantially identical to arrangement 310 except that, instead of a single processor and a single controller being used to control all systems, arrangement 410 includes separate SSA, SSF and SSVIE processors 422a, 422b, 422c, respectively, and separate SSA, SSF and SSVIE switch controllers 426a, 426b, 426c, respectively. Thus, the desired switch combinations for the SSA, SSF and SSVIE systems may be separately determined. Other aspects of the operation of antenna arrangement 410 are substantially similar to that of the preceding embodiments, and thus are not discussed in detail herein.

Yet another antenna arrangement 510 including both an SSF system and an SSVIE system is shown in FIG. 6. Arrangement 510 includes a dipole antenna 512, having interconnected dipole antenna elements 546, and a signal feed circuit 516 having coaxial cables 548 with a radio cable 550. Arrangement 510 also includes switchable, self-structuring variable impedance elements 540 disposed both between coaxial cables 548 and between dipole antenna elements 546. Elements 540 may be capacitive, inductive, resistive, or a combination of the three. Arrangement 510 further includes self-structuring feed switches 543, 544, 545. In one embodiment, feed switches 545 in antenna 512 may be two-way switches having one input and two outputs, such as single throw, double pole switches. Feed switch 544 may be a three-way switch having one input and three outputs, such as a single pole, triple throw switch. Feed switches 543 may be double pole, triple throw switches.

Antenna arrangement 510 may also include much the same components as the other embodiments disclosed above. For example, arrangement 510 may include a radio receiver (not shown) receiving signals from feed circuit 516, an algorithm processor (not shown) receiving an output signal from the radio receiver, and a switch controller (not shown) receiving an output signal from the processor. Control lines may be provided to interconnect the controller and elements 540 and switches 543, 544, 545. The operation of antenna arrangement 510 may be substantially similar to that of the other antenna arrangements disclosed above, and thus is not discussed in detail herein.

An antenna arrangement 610 including an SSPE system is shown in FIG. 7. Arrangement 610 includes a slot antenna 612 formed by a rectangular conductive substrate 632 having a rectangular throughslot 634 therein. Substrate 632 includes parasitic slots 652 having switches 614 disposed therein. Switches 614 each have an open state and a closed state. In the open state, switch 614 does not block or cause a discontinuity in slot 652, i.e., switch 614 has no effect. In the closed state, switch 614 does block slot 652 and thereby causes a discontinuity in slot 652. Arrangement 610 also includes a signal feed circuit 616 having a coaxial cable 648 connected to slot antenna 612.

Antenna arrangement 610 may also include much the same components as the other embodiments disclosed above. For example, arrangement 610 may include a radio receiver (not shown) receiving signals from feed circuit 616, an algorithm processor (not shown) receiving an output signal from the radio receiver, and a switch controller (not shown) receiving an output signal from the processor. Control lines may be provided to interconnect the controller and switches 614.

Parasitic elements such as slots 652 are not directly fed by the antenna's feed system, but because of their close proximity to the antenna these parasitic elements may directly affect the antenna transmit/receive characteristics. The effect of these parasitic elements may be determined by the parasitic element switch settings. All switches in the open state may result in the parasitic elements allowing slots 652 to act as director/reflector slots. Conversely, all switches in the closed state may result in slots 652 being shorted and thus removing their influence (i.e., no longer affecting the slot currents in the ground plane). Other aspects of the operation of antenna arrangement 610 may be substantially similar to that of the other antenna arrangements disclosed above.

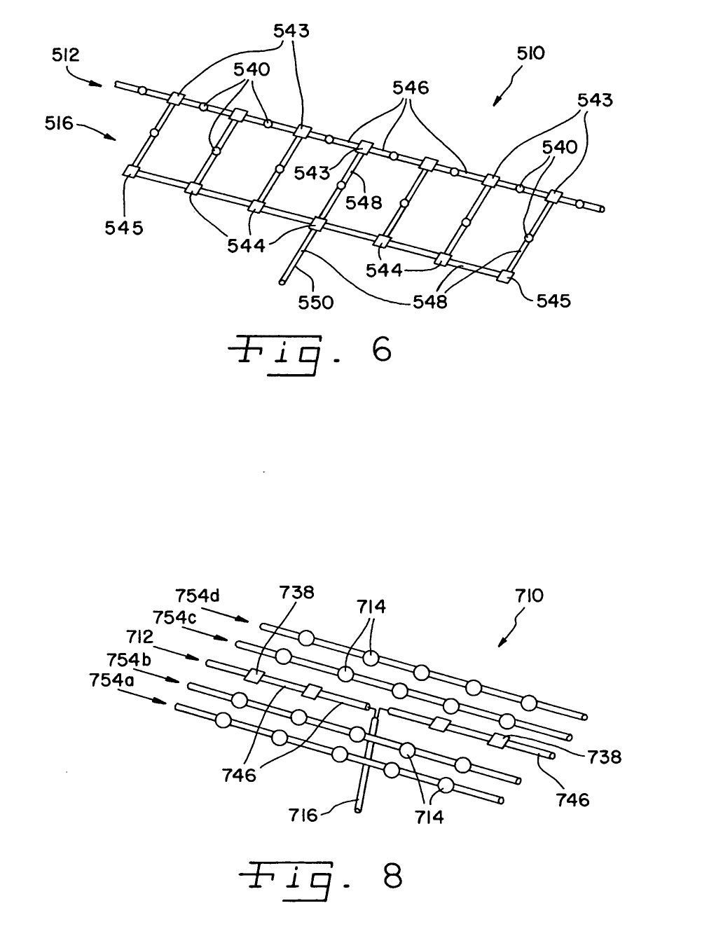

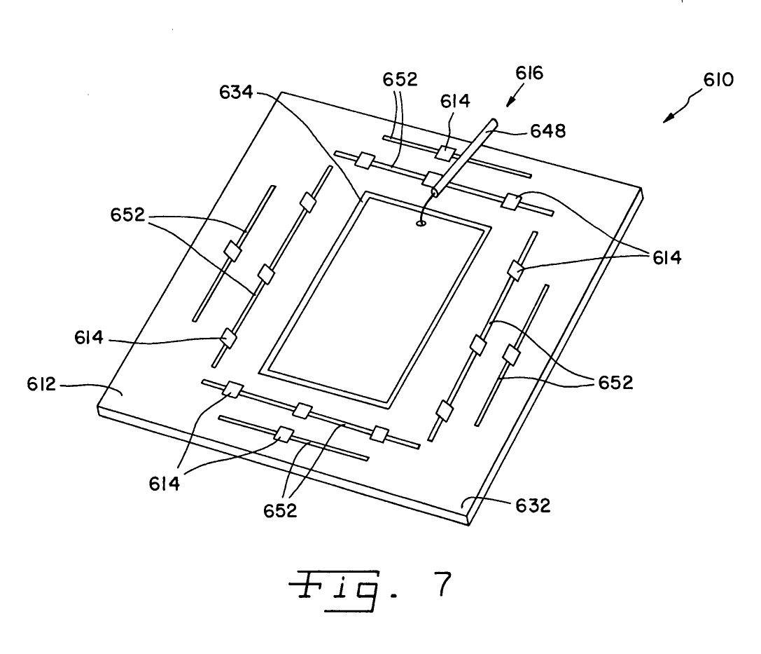

An antenna arrangement 710 using FM/TV wire array technology and including both an SSA system and an SSPE system is shown in FIG. 8. Arrangement 710 includes a dipole antenna 712, director/reflector elements 754a-d, and a signal feed circuit 716. Dipole antenna 712 may include dipole antenna elements 746 interconnected by SSA switches 738, which may be single pole, double throw electrical switches. Each of the parasitic elements 754a-d may operate either as a director or as a reflector. Elements 754a-d may include SSPE switches 714, which, like SSA switches 738, may be single pole, double throw electrical switches. The effects of director/reflector elements 754a-d of the FM/TV antenna may be determined by the states of SSPE switches 714.

Antenna arrangement 710 may also include much the same components as the other embodiments disclosed above. For example, arrangement 710 may include a radio receiver (not shown) receiving signals from feed circuit 716, an algorithm processor (not shown) receiving an output signal from the radio receiver, and a switch controller (not shown) receiving an output signal from the processor. Control lines may be provided to interconnect the controller and switches 714, 738. The operation of antenna arrangement 710 may be substantially similar to that of the other antenna arrangements disclosed above, and thus is not discussed in detail herein.

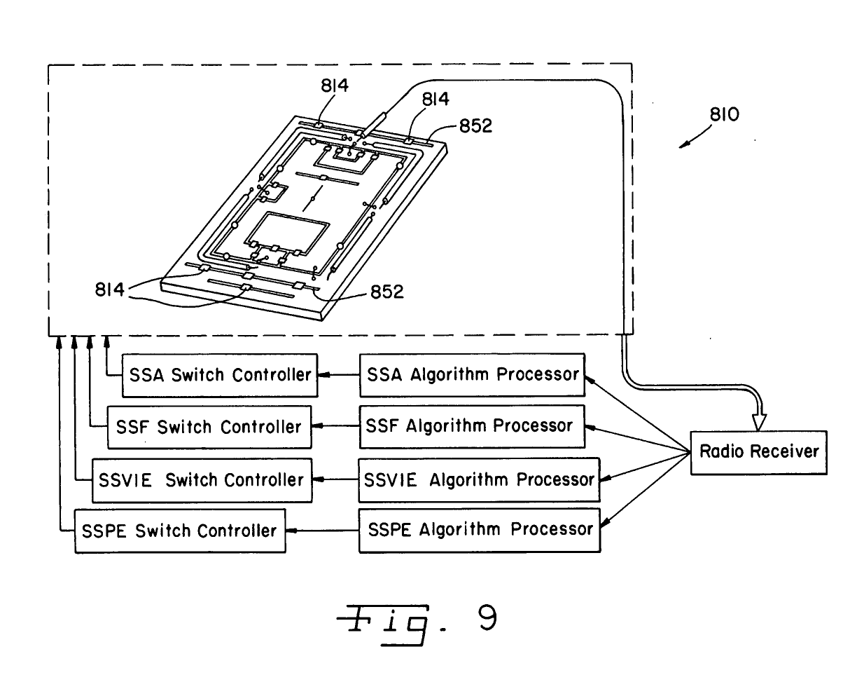

Another embodiment of an antenna arrangement 810 including an SSA system, an SSF system, an SSVIE system, and an SSPE system is shown in FIG. 9. Arrangement 810 is substantially identical to arrangement 410 except that arrangement 810 additionally includes an SSPE system having SSPE switches 814 disposed in slots 852. The operation of antenna arrangement 810 is substantially similar to that of the preceding embodiments, and thus is not discussed in detail herein.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. An antenna arrangement, comprising:
an antenna circuit configured to at least one of receive and transmit radio frequency signals;
a signal feed circuit coupled with said antenna circuit;
an antenna performance measuring device;
a performance-adjusting device including at least one of:
a self-structure feed switch system selectively interconnecting said antenna circuit and said signal feed circuit;
a variable impedance element disposed in one of said antenna circuit and said signal feed circuit; and
a switchable parasitic element coupled to said antenna circuit; and
a controller configured to control said performance-adjusting device.

2. The arrangement of claim 1 wherein said performance-adjusting device is configured to improve at least one of reception and transmission of said antenna arrangement.

3. The arrangement of claim 1 wherein said antenna circuit comprises a slot antenna circuit.

4. The arrangement of claim 1 wherein said antenna circuit comprises a dipole antenna circuit.

5. The arrangement of claim 1 wherein said controller is configured to control said performance-adjusting device dependent upon a signal received by a radio receiver via said antenna arrangement.

6. An antenna arrangement, comprising:
an antenna circuit configured to at least one of receive and transmit radio frequency signals;
a signal feed circuit;
at least one self-structure feed switch system selectively interconnecting said antenna circuit and said signal feed circuit; and
a controller configured to control said at least one self-structure feed switch.

7. The arrangement of claim 6 wherein said at least one self-structure feed switch system comprises a plurality of self-structure feed switches, each said self-structure feed switch selectively interconnecting said antenna circuit and said signal feed circuit at a respective location.

8. The arrangement of claim 6 wherein said antenna circuit comprises a slot antenna circuit.

9. The arrangement of claim 6 wherein said antenna circuit comprises a dipole antenna circuit.

10. The arrangement of claim 6 wherein said controller is configured to control said self-structure feed switch dependent upon a signal received by a radio receiver via said antenna arrangement.

11. An antenna arrangement, comprising:
an antenna circuit configured to at least one of receive and transmit radio frequency signals;
a signal feed circuit in communication with said antenna circuit;
a variable impedance element disposed in at least one of said antenna circuit and said signal feed circuit; and
a controller configured to control said variable impedance element.

12. The arrangement of claim 11 wherein said variable impedance element has at least one of a variable capacitance, a variable inductance, or a variable resistance.

13. The arrangement of claim 11 wherein said antenna circuit comprises a slot antenna circuit.

14. The arrangement of claim 11 wherein said antenna circuit comprises a dipole antenna circuit.

15. The arrangement of claim 11 wherein said controller is configured to control said variable impedance element dependent upon a signal received by a radio receiver via said antenna arrangement.

16. An antenna arrangement, comprising:
an antenna circuit configured to at least one of receive and transmit radio frequency signals;
a signal feed circuit in communication with said antenna circuit;
a switchable parasitic element coupled to said antenna circuit; and
a controller configured to control said switchable parasitic element.

17. The arrangement of claim 16 wherein said switchable parasitic element is disposed proximate said antenna circuit such that said switchable parasitic element affects performance of said antenna circuit.

18. The arrangement of claim 16 wherein said antenna circuit comprises a slot antenna circuit.

19. The arrangement of claim 16 wherein said antenna circuit comprises a dipole antenna circuit.

20. The arrangement of claim 16 wherein said controller is configured to control said switchable parasitic element dependent upon a signal received by a radio receiver via said antenna arrangement.
